(19) United States
(12) Patent Application Publication
(10) Pub. No.: US 2005/0250503 A1
(43) Pub. Date: Nov. 10, 2005

(54) Wireless networks frequency reuse distance reduction

(76) Inventor: David M. Cutrer, San Ramon, CA (US)

Correspondence Address: FOOTHOLL LAW GROUP, 3333 BOWERS AVE., #130, SANTA CLARA, CA, 95054, US

(21) Appl. No.: 11/123,571

(22) Filed: May 5, 2005

Related U.S. Application Data
(60) Provisional application No. 60/568,511, filed on May 5, 2004.

(51) Int. Cl. H04Q 7/20

(52) U.S. Cl. 455/447; 370/334

(57) ABSTRACT

A method for improving spectral efficiency of a wireless network is provided. A microcell concept is utilized to improve isolation between the reuse pairs of antennas, thus significantly reducing reuse distance and increasing the network capacity. Radiation profiles of the reuse pair of antennas are positioned in a way which increases the isolation and thus improves the signal to interference ratio. Directional antennas are employed to further increase isolation between the reuse pair. Shielding from the surrounding structures is utilized to further increase the isolation. Additional antennas are placed near the cell boundary to further increase the signal to interference ratio and reduce deep fades in multipath environment.

This application claims the benefit of U.S. Provisional Application No. 60/568,511 filed on May 5, 2004.

### BACKGROUND OF THE INVENTION

1. Field of the Invention

This invention relates to a wireless communications system and more particularly to increasing the spectral communications efficiency using an improved frequency reuse scheme.

2. Description of Related Art

The wireless communication channel is a difficult medium, susceptible to noise, interference, blockage and multipath. These channel impediments change over time because of user movement. These characteristics impose fundamental limits on the range, data rate, and reliability of communications over wireless links. These limits are determined by several factors, most significalty the propagation environment and the user mobility. For example, the wireless channel for an indoor user at walking speeds typically supports higher data rates with better reliability than the channel of an outdoor user surrounded by tall buildings and moving at high speed. A description of wireless communications channels may be found in “High Performance Communications Networks” by J. Walrand and P. Varaiya, Academic Press, 2000.

Wireless systems use the atmosphere as their transmission medium. Signals are sent across this medium by inducing a current of sufficient amplitude in an antenna whose dimensions are approximately the same as the wavelength of the generated signal. In a typical situation the transmitted signal has a direct path component between the transmitter and the receiver that is either attenuated or obstructed. Other components of the transmitted signal, referred to as multipath components, are reflected, scattered, or diffracted by surrounding objects and arrive at the receiver shifted in amplitude, phase, and time relative to the direct signal path. The received signal may also experience interference form other users in the same frequency band. Based on the foregoing, the wireless communications channel has four main characteristics: path loss, shadowing, mulitpath and interference.

Path loss determines how the average received signal power decreases with the distance between the transmitter and the receiver, i.e., it is a ratio of the received power to the transmitted power for a given propagation path and is a function of propagation distance.

Shadowing characterizes the signal attenuation due to obstructions from the buildings or other objects. Hence, the received signal power at equal distances from the transmitter will be different, since some locations have more severe fading than the others. Random signal variations due to the obstructing objects is referred to as shadow fading.

Multipath fading is caused by constructive and destructive combining of the multipath signal components which causes random fluctuations in the received signal amplitude (flat fading) as well as self-interference (inter-symbol interference or frequency selective fading). Flat fading describes the rapid flactuations of the received signal power over short time periods or over short distances. Such fading is caused by the interference between different mulitpath signal components that arrive at the receiver at different times and are subject to constructive and destructive interference. This constructive and destructive interference generates a standing wave pattern of the received signal power relative to distance or, for a moving receiver, relative to time. In flat fading the received signal power falls well below its average value. This causes large increase in Bit Error Ratio (BER). Although BER can be reduced by increasing the transmitted signal power, most carriers choose not to do this. Therefore, for typical user speeds and data rates, the fading will affect many bits, causing long strings of bit errors typically referred to as error bursts.

Inter-symbol interference (ISI) is another impairment introduced by multipath. ISI becomes a significant problem when the maximum difference in the path delays of the different multipath components, referred to as mulitpath delay spread, exceeds a significant fraction of a bit time. The result is self-interference, since a mulitpath reflection carrying a given bit transmission will arrive at the receiver simulatenoulsy with a different (delayed) mulitpath reflection carrying a previous bit transmission.

Interference characterizes the effects of other users operating in the same frequency band either in the same or another system. Typical sources of interference are adjacent channel interferance, caused by signals in adjacent channels with signal components outside their allocated frequency range, and narrowband interference, caused by users in the other systems operating in the same frequency band.

Efficient cellular systems are interference limited, that is, the interference dominates the noise floor since otherwise more users could be added to the system. As a result, any technique to reduce interference in cellular system leads to an increase in system capacity and performance. Some general methods for interference reduction, either in use today or proposed for near future include cell sectorization, directional and smart antennas, multiuser detections and dynamic channel and resource allocation.

For the numerous reasons stated above, there is a need for an improved antenna configuration not available in a traditional tower rooftop model that reduces reuse distances and improves the wireless signal strength while simultaneously reducing interference.

This disclosure presents these novel antenna configurations and an associated measurement technique for achieving and validating short reuse distances in a microcell system.

### SUMMARY OF THE INVENTION

Accordingly, an object of the present invention is to provide a method for reducing a reuse distance in a wireless network.

Another object of the present invention is to selectively direct radiation profiles of antennas in a reuse pair away from each other in horizontal or vertical plane and reduce interference between them, by mechanical or electrical tilting.

Yet another object of the present invention is to employ directional antennas and direct their radiation profiles away from each other up to 180 degrees in order to reduce the interference between the reuse sites.

Still another object of the present invention is to utilize shielding commonly found in mass event forums to reduce interference between the reuse sites.

An object of the present invention is to place at least one antenna near a node boundary to reduce interference between the reuse sites.

Another object of the present invention to employ a spatially distributed antenna to reduce the interference between the reuse sites.

Still another object of the present invention is to achieve signal to interference (C/I) ratio of about 22 db.

Yet another object of the present invention is to achieve signal to interference (C/I) ratio of at least 22 db.

Another object of the present invention is to enable frequency reuse between a microcell and a macrocell.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

### BRIEF DESCRIPTION OF THE DRAWINGS

FIG. 1 shows a typical hexagonal cell structure with a reuse distance of about 5000 meters.

FIG. 1A defines a cell.

FIG. 1B shows a node of the device of this invention.

FIG. 2A shows typical reuse antenna configuration.

FIG. 2B shows the back tilted antenna of this invention.

FIG. 3 shows typical directional antennas employed in reuse configuration.

FIG. 4 shows the device of FIG. 3 positioned to reduce interference.

FIG. 5 employs shielding to reduce interference between the reuse pair.

FIG. 6 is a representation of low signal strength at the node boundary.

FIG. 7 shows signal strength at the node boundary if additional antennas are employed.

### DETAILED DESCRIPTION

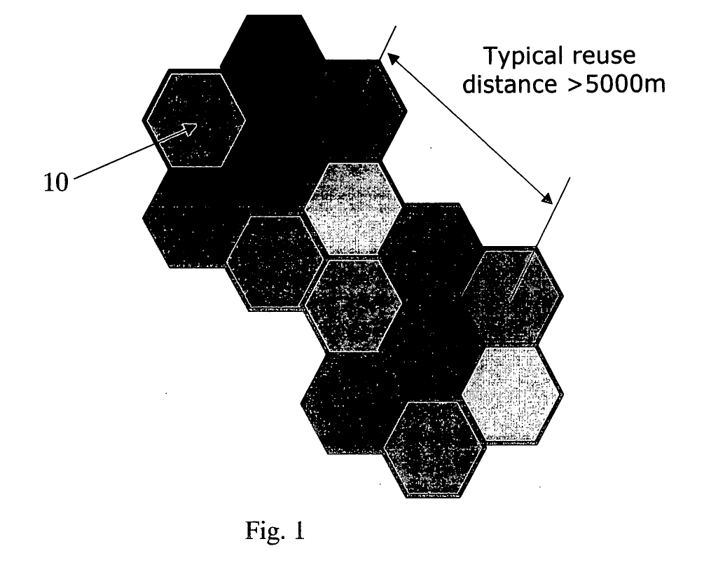

Traditional wireless networks support high numbers of wireless users with limited radio spectrum by implementing a cellular network where blocks of frequency channels are reused throughout the network. The frequency reuse, however, becomes a major source of interference in wireless networks. Frequency reuse exploits the path loss to reuse the same frequency spectrum at spatially separated locations. Specifically, the coverage area of a wireless system is divided into non-overlapping cells where some set of channels is assigned to each cell. This same set of channels is then used in another cell some distance away. The traditional frequency reuse plan implements a hexagonal cell structure with 7 blocks of frequency channels as shown in FIG. 1 where 10 is a typical cell. A cell is defined as consisting of a base station with typically several tranceivers, a tower and antennas. In this case, the antennas are mounted on towers and/or rooftop sites and the reuse distance is limited by the propagation characteristics of the tower site including the antenna type, surrounding terrain, and frequency. Prior art has developed a number of antenna configurations and models to predict the propagation characteristics from a tower site and the resulting reuse distance that can be achieved. Typical frequency re-use distances in the traditional cellular scheme are on the order of many kilometers (e.g. 5 km).

Due to the continued increase in cellular traffic, bandwidth requirements, and the desire to cover special venues, the need to deploy smaller cells (microcells) cells has emerged. The ability to achieve tighter reuse than is currently available from the traditional tower architecture is a critical need that the wireless service providers have as it facilitates network expansion using the precious and limited spectrum resources that each operator has. In fact, several operators in the US are looking at metro “re-banding” programs that will expand their long-term capacity capabilities in critical metro areas. There is also an emerging need to deploy more capable reuse schemes in unlicensed wireless networks such as 802.11, and the techniques presented in this disclosure can be directly applied to these networks. Special venues include, but are not limited to stadiums, racetracks, office buildings, subway systems, and universities.

Typical microcell frequency reuse distances are fractions of a kilometer (e.g. 500 m or less). Prior art methods for determining reuse distances and antenna designs for achieving this tight reuse are not applicable due to the short propagation distance and the near field structures involved such as city buildings or metal grandstands in the case of a stadium. An example of a microcell reuse application may be a racetrack where many antennas are used to provide coverage and capacity at a racetrack. Thus, for a given coverage area, a system with many microcells has a higher number of users than a system with few macrocells. Small cells also have better propagation conditions since the lower base stations have reduced shadowing and multipath.

One of the key innovations to of this invention aimed at achieving tight reuse between antennas in microcell applications is finding antenna configurations that can maximize the desired signal coverage (“C”) while minimizing the interference to the reuse node (“I”). This will maximize the resulting carrier to interference level (“C/I”) that ultimately will determine the usable coverage area of the antenna. For example, typical C/I levels need to be greater than 100 (20 dB) for many cellular system to operate properly.

FIG. 1B shows a node as defined in this invention, including an input signal, transmitter and receiver (transceiver) and some number of antennas.

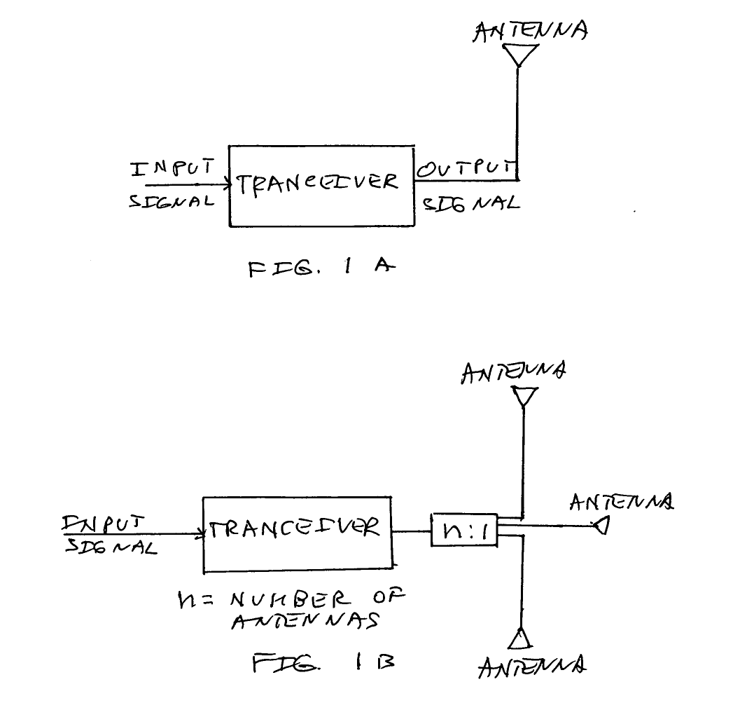

Shown in FIG. 2A is a typical reuse antenna arrangement with two antennas 20 and 22 operating at same frequency and free space 24 between their radiation patterns serving to isolate the antennas 20 and 22 from interfering with each other. With free space being the only isolation, the antennas 20 and 22 need to be spaced far apart, thus reducing the spectral efficiency of the cellular.

FIG. 2B shows an embodiment of this invention where the antennas 20 and 22 tilted away from each other. In many cases, antennas can be back tilted to gain additional isolation between the reuse antennas and, in turn, reduce interference. This is achieved because in addition to the free space loss between the antennas, the geometry of the antenna patterns are being used to further isolate the reuse locations. Furthermore, often the back tilting can be done without any compromise to the desired signal, thus increasing the C/l. For example, at a stadium the antennas can be mounted low at ground level and pointed up into the grandstands where the wireless subscribers are located. Note that the “back tilt” can be both up and down tilt, and can also be implemented using both mechanical and electrical tilt, the electrical tilt being accomplished by suitable selection of material with properties sensitive to voltage application. Person skilled in the art will be able to make this determination.

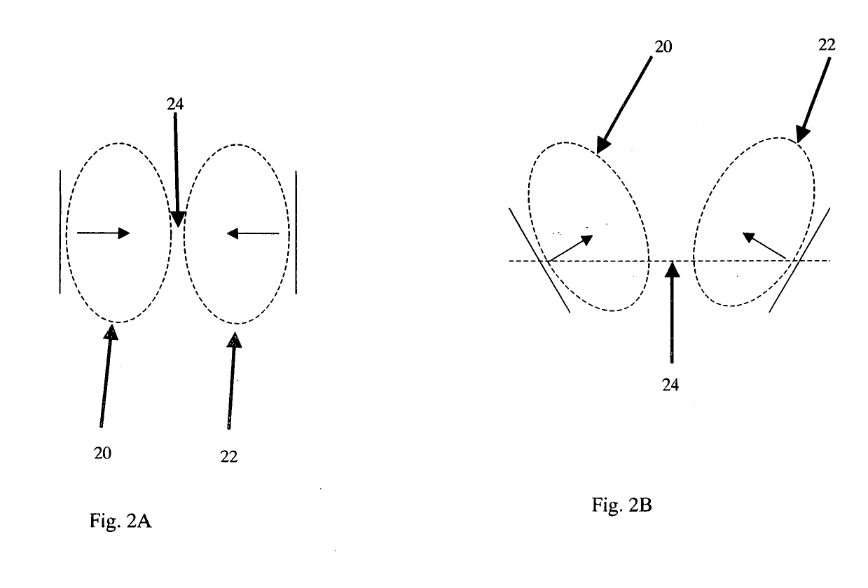

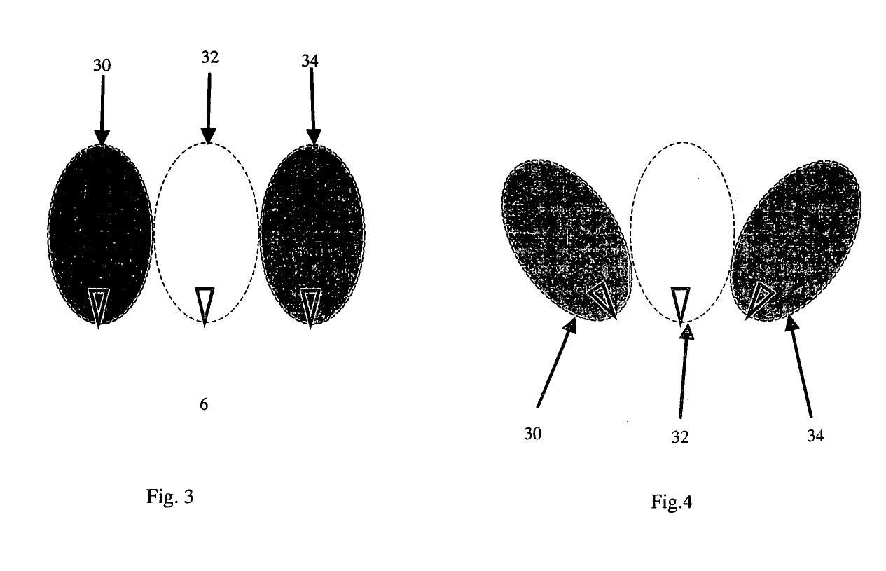

Shown in FIG. 3 is another antenna arrangement in which directional antennas 30 and 34 are positioned as a reuse pair and operating at the same frequency. Antenna 32 operates at a different frequency from the antennas 30 and 34. The free space loss serves to provide isolation between the antennas 30 and 34. Moving the directional antennas 30 and 34 at the ends towards the middle, as shown in FIG. 4, and then angling the antennas away from each other provides additional isolation, while still covering the desired area. In the extreme case, two antennas can be pointed 180 degrees away from each other in a “back-to-back” configuration. This is a particularly good way to achieve reuse if the geometry of the coverage area will allow such a configuration.

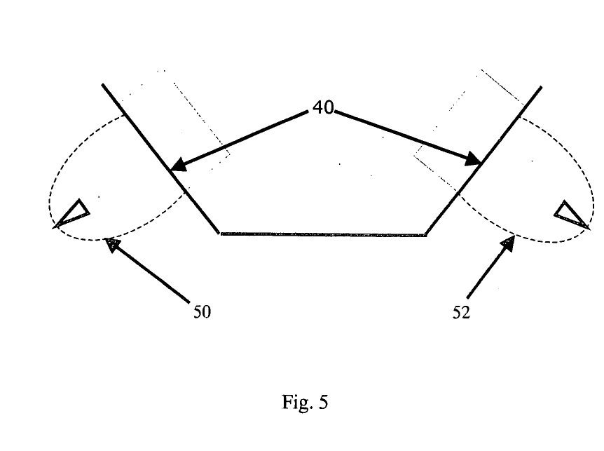

Referring to FIG. 5, another embodiment of the present invention shows the antennas 50 and 52 as a reuse pair operating at the same frequency. Positioned between the antennas 50 and 52 is stadium seating 40 that is usually metallic and it absorbs the radiation aimed form one of the antennas in the direction of the other. The shielding also shields the microcell form the other tower and rooftop sites in the network (macrocells). Other similar shielding arrangements may also be employed.

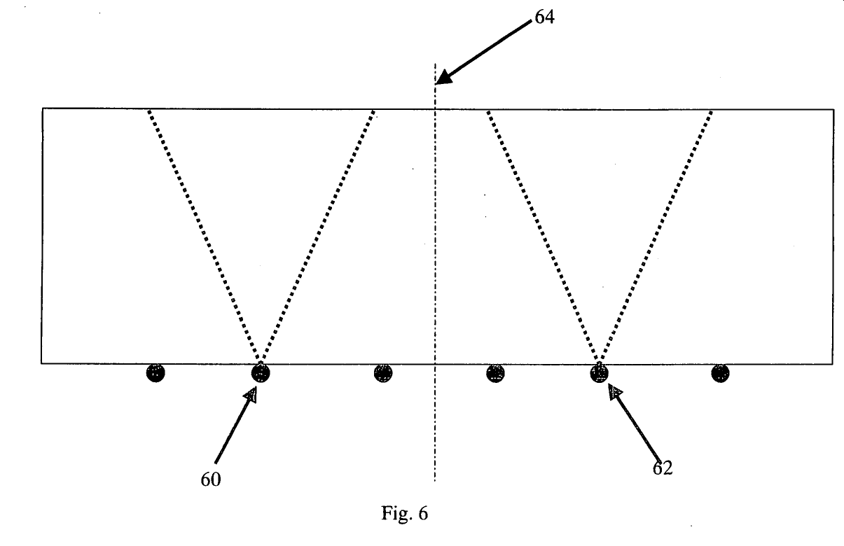

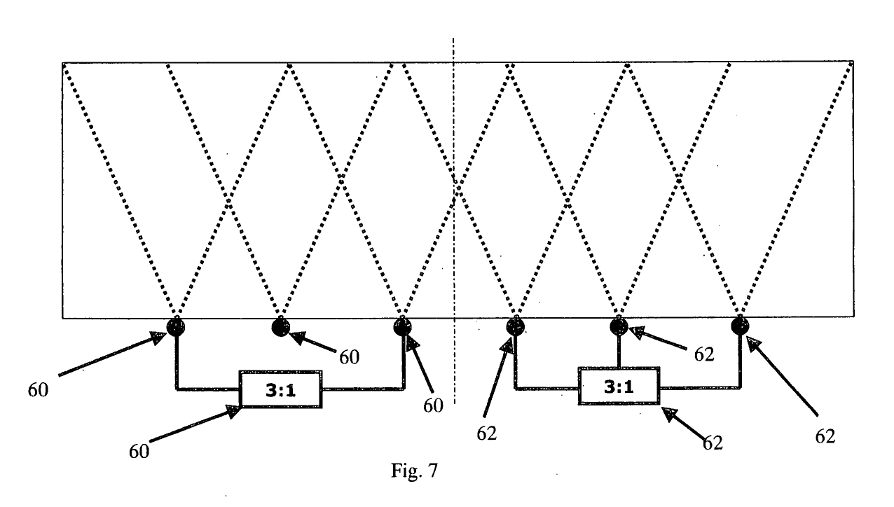

FIG. 6 shows the signal distribution between the antennas 60 and 62, with the signal strength at the cell boundary 64 being drastically reduced due to the directionality of the of the antennas 60 and 62 radiation pattern. This will mean that the C/I at the cell boundary will be the lowest in the serving area. Note that the opportunity to do this in a traditional tower network is not feasible due to the fact that the cell boundary is a mile or more away from the tower. In a microcell network, the cell boundary may only be 200 feet away from the main serving antenna. The addition of antennas 60 and 62 at or near the cell boundary 64 will provide increased signal at the cell boundary 64 as illustrated in FIG. 7. This technique can be used to increase the serving area of a cell, or to reduce the reuse distance between cells or both. This example has shown the addition of two additional antennas; however, in the general case there can be multiple antennas, or even radiating cable, which is a spatially distributed antenna. A person skilled in the art will be able to determine a proper type of antenna.

Yet another benefit of using multiple antennas in a microcell reuse environment is the reduction of deep fades in a multipath environment. With a single antenna, there are multiple locations in the coverage area where multipath signals can interfere destructively and reduce the desired receive signal by up to 15 dB. This is particularly true if the serving area does not have a line of sight relationship with the antenna. The deep fading phenomenon is significantly mitigated when using multiple antennas since the probability that the receiver will be in a deep fade with all of the transmit antennas at the exact same location is small.

1. A method for improving frequency reuse in a wireless communication system, comprising:
placing at least one antenna in each node of a plurality of nodes, each antenna
having at least one operating frequency and a radiation profile;
and selectively directing the radiation profiles of the at least one antenna.

2. The method of claim 1 wherein at least one antenna is directed away from the vertical and distally from another antenna.

3. The method of claim 1 wherein at least one antenna is directed away from the horizontal and distally from another antenna.

4. The method of claim 1 wherein the radiation profile of at least one antenna is electrically directed distally from the radiation profile of at least another antenna.

5. The method of claim 4 wherein the antennas further comprise voltage responsive materials.

6. The method of claim 1 wherein the at least one antenna are directional antennas.

7. The method of claim 6 wherein the operating frequency of an antenna is not the same as that of the antennas immediately adjacent to said antenna.

8. The method of claim 6 wherein operating frequencies of antennas immediately adjacent to said antenna are identical.

9. The method of claim 8 wherein said immediately adjacent antennas are directed away from the horizontal and distally from the antenna thereinbetween.

10. The method of claim 9 wherein said immediately adjacent antennas are directed about 180 degrees away from each other.

11. The method of claim 1 wherein the at least one antenna further comprise shielding thereinbetween.

12. The method of claim 11 wherein the shielding is a people holding structure.

13. The method of claim 6 wherein at least one of the directional antennas are positioned proximately to the node boundary.

14. The method of claim 13 wherein at least one of the directional antennas are positioned at the node boundary.

15. The method of claim 6 wherein the at least one of the directional antennas is a spatially distributed antenna.

16. The method of claim 15 wherein the spatially distributed antenna is a radiating cable.

17. The method of claim 1 wherein the ratio of the signal strength of the radiation pattern of an antenna to the interference from another antenna operating at the same frequency is about 22 db.

18. The method of claim 1 wherein the ratio of the signal strength of the radiation pattern of an antenna to the interference from another antenna operating at the same frequency is at least 22 db.

19. A method for frequency reuse between a microcell and a macrocell in a wireless communication system, comprising:
placing at least one first antenna in at least one node, each first antenna having at least one operating frequency and a radiation profile;
placing at least one second antenna into a microcell, each at least one second antenna having the same operating frequency as each at least one first antennas;
and selectively directing the radiation profile of the at least one first antenna.

20. The method of claim 19 wherein said at least one first antenna further comprise shielding from radiation of other antennas.
